(19) United States
(12) Patent Application Publication
(10) Pub. No.: US 2010/0203484 A1
(43) Pub. Date: Aug. 12, 2010

(54) Alphabitz / A B C sticks

(76) Inventors: Rodger Jay Wescott, Tracy, CA (US); Laura Ann Wescott, Tracy, CA (US); Lauren Christine Wescott, Tracy, CA (US)

Correspondence Address: Rodger Jay Wescott, 445 Hawthome Dr., Tracy, CA, 95376, US

(21) Appl. No.: 12/322,872

(22) Filed: Feb. 9, 2009

(51) Int. Cl. G09B 1/00

(52) U.S. Cl. 434/160

(57) ABSTRACT

The invention Alphabitz/ABC Sticks is an educational toy to be used in teaching the proper formation of the letters of the alphabet. Alphabitz/ABC Sticks consists of twenty pieces/sticks cut into, curves, half circles, straits, straits with angled ends and a corner piece. By using the pieces in conjunction with one another a person is able to form every letter of the alphabet in upper and lower case form.

### CROSS-REFERANCE TO RELATED APLICATIONS

Not applicable

### STATEMENT REGARDING FEDERALLY SPONSORED RESEARCH OR DEVELOPMENT

Not applicable

### REFERENCE TO SEQUENCE LISTINGS, A TABLE, OR A COMPUTER PROGRAM LISTING COMPACT DISK APPENDIX

Not applicable

### BACKGROUND OF THE INVENTION

This invention is an educational toy for the purpose of teaching children how to properly form each letter of the alphabet.

### BRIEF SUMMARY OF THE INVENTION

The invention consists of sticks made from wood/plastic, cut into curves, straits, shapes and angles. These sticks can be laid out to form the letters of the alphabet (one letter at a time) for the purpose of teaching children the proper formation of each letter of the alphabet.

### BRIEF DESCRIPTION OF SEVERAL VIEWS OF THE DRAWING

FIG. 1A shows the cuts to be made for the 10 inch ring as described in Step-1

FIG. 2A shows the cuts to be made for the 5 inch ring as described in Step-2

FIG. 3A shows the cuts to be made for the elbow shaped piece as described in Step-3

FIG. 4A shows the 2 ten inch sticks after corners have been cut off as described in step-4

FIG. 5A shows the 10 pieces after being cut (2-10 inch pieces/4-4⅝ inch pieces/4-2½ inch pieces) as described in Step-5

### BLACK AND WHITE PHOTOS

Seven pages of black and white photos that shows how the invention is used to form each letter of the alphabet. Page 1-ABCD/Page 2-EFGH/Page 3-IJKL/Page 4-MNOP/Page 5-QRST/Page 6-UVWX/Page 7-YZ

### DETAILED DISCRIPTION OF THE INVENTION

The invention (Alphabitz/A B C Sticks) consist of twenty individual pieces cut into shapes, curves half circles and straits. By combining the individual pieces a person is able to form all of the letters of the alphabet (one at a time) The following five step process is how to make the invention

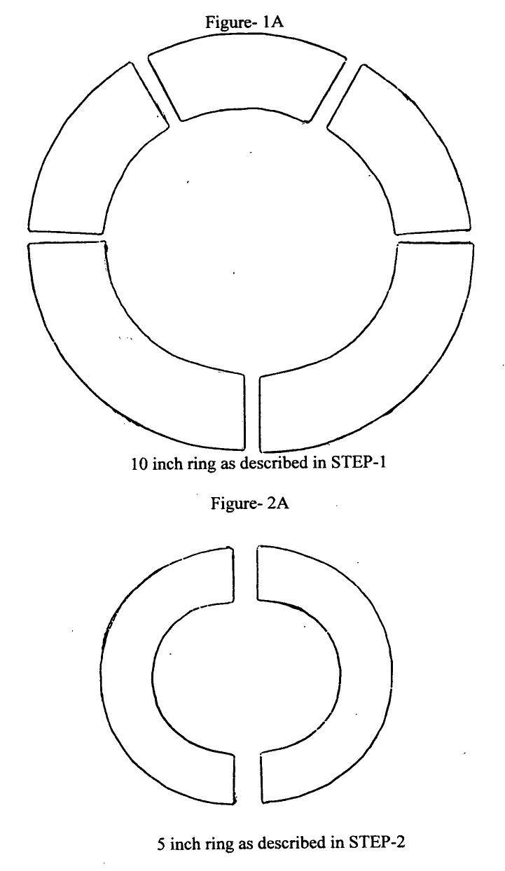

### Step-1/FIG. 1A

Using flat sheet material ¾ inch thick, Cut out a ring with an outside diameter of 10 inches and an inside diameter of 8½ inches. Using the outside diameter line cut the ring in half, take one half of the ring and cut it in half leaving two equal curved pieces. Using the second half of the ring cut it into three equal parts leaving three curved pieces. These five pieces are finished.

### Step-2/FIG. 2A

Using flat sheet material ¾ inch thick, Cut out a ring with an outside diameter of 5 inches and an inside diameter of 3½ inches. Using the outside diameter line cut the ring in half leaving two equal half ring pieces. These two pieces are finished.

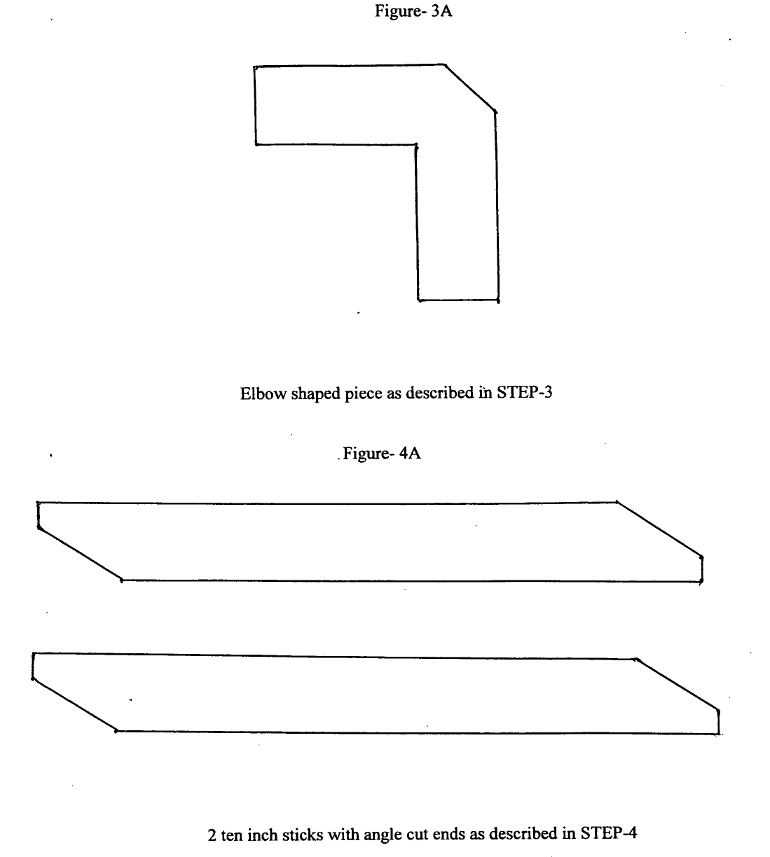

### Step-3/FIG. 3A

Using flat sheet material ¾ inch thick, Cut out an elbow piece ¾ of an inch wide with outside lines of 2.25×2.25 inches, where the two outside lines meet (corner) make a dog-ear cut of ½ inch from each side equally This will leave the outside lines of the elbow measuring from one end as follows, 1.75 inches at witch point there is a 45 degree angle to the right, outside line continues ⅝ of an inch to another 45 degree angle to the right, outside line continues 1.75 inches to the other end of the elbow. This one piece is finished.

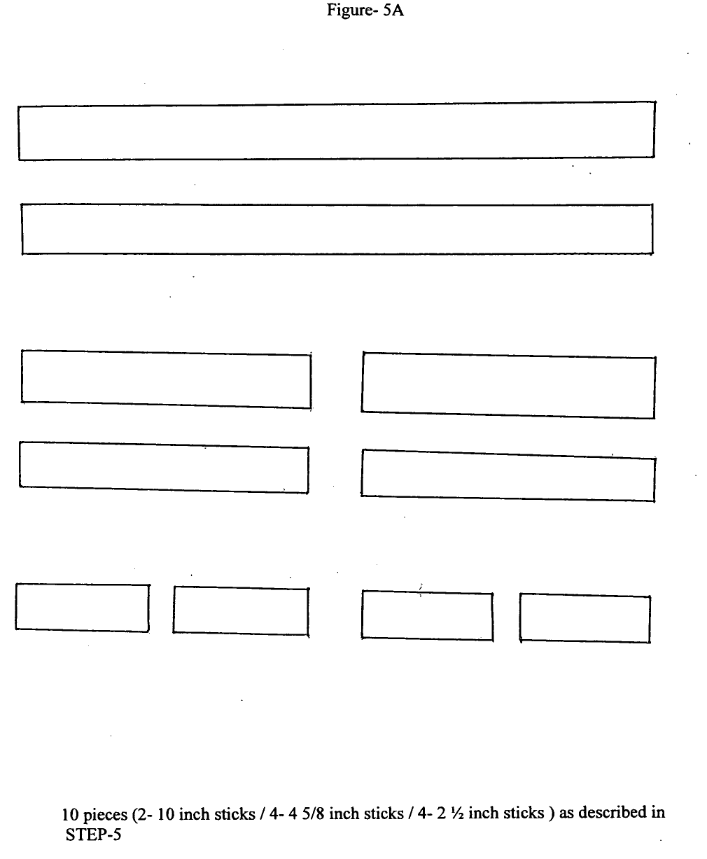

### Step-4/FIG. 4A

Using material ¾ inch thick×¾ inch wide×20 inches long, Cut the material in half leaving two equal pieces (sticks) ¾ inch×¾ inch×10 inches long. Lay one of the pieces flat on a table, looking at the piece from an over head horizontal view (over head view of the piece is 10 inches left to right) Cut the top right corner off. Cut is to start at the right end of the stick, ¼ inch above the bottom right corner angling up and left, ending ¾ inch to the left of the top right corner. The small corner piece that was cut off will measure ½ inch on the right×¾ on the top×⅞ on the angle. That end is done. Using the same over head view cut the bottom left corner off. Cut is to start at the left end of the Stick ¼ inch down from the top left corner angling down and right, ending ¾ inch to the right of the bottom left corner. The small corner piece that was cut off will measure ½ inch on the left×¾ inch on the bottom×⅞ on the angle. This stick is done.

Repeat this process on the second 10 inch stick.

Only the two 10 inch sticks will be used. (Small corner pieces will not be used) Using the same over head view. Each stick should measure as follows 9¼ inches across the top×⅞ inch at top right angle×¼ on right end×9¼ inches across the bottom×⅞ inch at bottom left angle×¼ inch on left end. These two pieces are done.

### Step-5/FIG. 5A

Using material ¾ inch thick×¾ inch wide×47½ inches long (one long stick). The stick will be cut into 10 pieces as follows, two pieces 10 inches long, four pieces 4⅝ inches long, four pieces 2¼ inches long. All cuts are made squarely across stick and thickness and width remain the same ¾×¾ inch. These ten pieces are done.

1. By designing and Engineering these curves, shapes, angles, straits and there sizes in a manner as to work in conjunction with one another allowing for every letter of the alphabet to be formed (one at a time) using the pieces of this invention. I claim to be the inventor of this invention.
